(19) United States
(12) Patent Application Publication
(10) Pub. No.: US 2018/0098031 A1
(43) Pub. Date: Apr. 5, 2018

(54) VIDEO CONFERENCING COMPUTER SYSTEMS

(71) Applicant: Virtual Legal Proceedings, Inc., Cary, NC (US)

(72) Inventors: Michael M. Daniels, Cary, NC (US); Mason Ambrose, Apopka, FL (US)

(21) Appl. No.: 15/724,925

(22) Filed: Oct. 4, 2017

Related U.S. Application Data
(60) Provisional application No. 62/403,966, filed on Oct. 4, 2016.

(51) Int. Cl. H04N 7/15; G10L 15/26; H04N 5/93; G11B 27/10; G10L 25/57; G06F 17/30

(52) U.S. Cl. CPC H04N 7/155; G10L 15/265; H04N 5/9305; G06F 17/30787; G10L 25/57; G06F 17/30796; G11B 27/102

(57) ABSTRACT

A video conferencing computer system is programmed for establishing, for a deposition, a videoconferencing session between users including at least a witness and a deposing attorney by transmitting display information to a respective user computer for each user over a data communications network. The computer system is programmed for presenting, during the deposition and at each user computer, a graphical user interface displaying a real-time video of the witness captured from a camera and a view of a selected document so that each user computer displays in real-time the view of the selected document. The computer system is programmed for storing, after the deposition, a video file of the real-time video of the witness and a timestamped record of a plurality of displayed documents displayed in the second panel during the deposition.

### PRIORITY CLAIM

This application claims the benefit of U.S. Provisional Patent Application Ser. No. 62/403,966 filed Oct. 4, 2016, the disclosure of which is incorporated herein by reference in its entirety.

### TECHNICAL FIELD

This specification relates generally to video conferencing computer systems, for example, video conferencing servers that enable document sharing by transmitting document state information.

### BACKGROUND

Various types of online collaborative services are currently in use, including web seminars (“webinars”), webcasts, and peer-level meetings. In general, online collaboration services are implemented using conventional Internet technologies, such as TCP/IP connections and HTTP web pages. Some services allow real-time point-to-point communications as well as multicast communications from one sender to many receivers. Applications for online collaboration services include meetings, training events, lectures, or other types of presentations from a computer to other computers over a network.

The traditional legal deposition process requires attorneys to plan depositions weeks or months in advance due to scheduling and travel conflicts. Additionally, the traditional legal deposition process requires the presence of a court reporter in order to generate the transcript. There are existing online collaborative services that implement remote legal deposition products by videoconferencing; however, the existing services generally require the presence of a court reporter.

### SUMMARY

This specification describes video conferencing computer systems. In some examples, a computer system is programmed for establishing, for a deposition, a videoconferencing session between users including at least a witness and a deposing attorney by transmitting display information to a respective user computer for each user over a data communications network. The computer system is programmed for presenting, during the deposition and at each user computer, a graphical user interface displaying: a first panel displaying a real-time video of the witness captured from a camera coupled to or integrated with the user computer of the witness; and a second panel displaying a view of a selected document from a number of electronic documents uploaded by the deposing attorney so that each user computer displays in real-time the view of the selected document. The computer system is programmed for storing, after the deposition, a video file of the real-time video of the witness and a timestamped record of a plurality of displayed documents displayed in the second panel during the deposition.

In some examples, a computer system is programmed for establishing a videoconferencing session between users by transmitting display information to a respective user computer for each user over a data communications network. The computer system is programmed for presenting, at each user computer, a graphical user interface displaying a view of a document so that each user computer displays in real-time the view of the selected document. The computer system is programmed for, in response to a controlling user manipulating the document in the videoconferencing session, updating the view of the document at each other user computer by transmitting document state information to each other user computer over the data communications network.

In some examples, a computer system is programmed for providing, to a user computer over a data communications network, a video viewing application. The computer system is programmed for receiving, from the video viewing application executing on the user computer, a search request including one or more search terms to search for in a video having a corresponding audio file. The computer system is programmed for, in response to receiving the search request, providing one or more search results to the video viewing application executing on the user computer, each search result indicating a portion of the video where a corresponding portion of the audio file has been transcribed to text matching the one or more search terms.

### BRIEF DESCRIPTION OF THE DRAWINGS

FIG. 1 illustrates a network environment for an example videoconferencing computer system;

FIG. 2 is a block diagram of the example videoconferencing computer system;

FIG. 3 is a flow diagram of a method performed by the deposition facilitator;

FIG. 4 is a flow diagram of a method performed by the real-time document sharer;

FIG. 5 is a flow diagram of a method performed by the video transcript searcher;

FIG. 6 shows a screen shot of an example video conferencing GUI;

FIG. 7 shows a screen shot of an example video conferencing GUI including a live transcription window;

FIG. 8 shows a detailed view of an example of the live transcription window; and

FIG. 9 shows a screen shot of an example video conferencing GUI for analyzing a deposition videoconference.

### DETAILED DESCRIPTION

The example computer systems described in this document implement technological solutions for both technical problems and other problems. For example, compared to computer systems using conventional online collaborative services for legal depositions, the example computer systems can use less network bandwidth, less disk storage space, and fewer processing resources. The example computer systems can be used to allow the entire deposition process to be conducted remotely—thus eliminating travel considerations and easing scheduling difficulties. Additionally, the computer systems can produce as an output a recorded video which provides a better form of evidence than a transcript in a legal setting.

The computer systems described in this specification may be implemented in hardware, software, firmware, or combinations of hardware, software and/or firmware. The computer systems described in this specification may be implemented using a non transitory computer storage medium storing one or more computer programs that, when executed by one or more processors, cause the one or more processors to implement one or more aspects of a videoconferencing system. Computer storage media suitable for implementing the computer systems described in this specification include non-transitory computer storage media, such as disk memory devices, chip memory devices, programmable logic devices, random access memory (RAM), read only memory (ROM), optical read/write memory, cache memory, magnetic read/write memory, flash memory, and application specific integrated circuits. A computer storage medium used to implement the computer systems described in this specification may be located on a single device or computing platform or may be distributed across multiple devices or computing platforms.

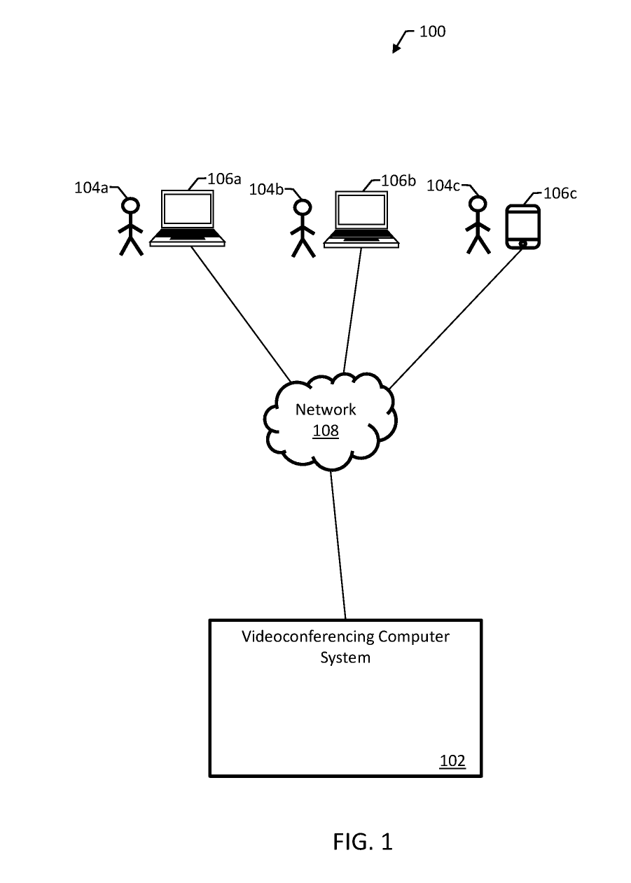

FIG. 1 illustrates a network environment 100 for an example videoconferencing computer system 102. The videoconferencing computer system 102 is programmed to establish a videoconferencing session between several users 104a-c. The users 104a-c access the videoconferencing session on user computers 106a-c.

Each of the user computers 106a-c is a device having one or more processors, memory, a display, and a user input device. For example, a user computer can be a laptop, a tablet, or a mobile phone. Typically, a user computer also has a camera and a microphone, which can be integrated with the user computer or in communication with the user computer by a cable or a wireless link. The user computers 106a-c communicate with the videoconferencing computer system 102 by exchanging messages over a data communications network 108.

The videoconferencing computer system 102 can be implemented as a server, e.g., providing a cloud computing service by transmitting web pages to user devices for display in web browsers. In operation, the videoconferencing computer system 102 provides one or more videoconferencing services to the users 104a-c. For example, the videoconferencing computer system 102 can send video and audio feeds of the users 104a-c, captured by cameras and microphones, to the user devices 106a-c so that the users 104a-c can see and hear one another.

In some examples, a first user 104a is a deposing attorney and a second user 104b is a witness, and the videoconferencing computer system 102 is programmed to facilitate a deposition of the witness 104b by the deposing attorney 104a. In some examples, the videoconferencing computer system 102 is programmed to provide real-time document sharing. The term “real-time” is used in this document to indicate services that are real-time or are near real-time as limited by latency in the system, e.g., processing or network latency. In some examples, the videoconferencing computer system 102 is programmed to provide a search service for transcribed video recordings.

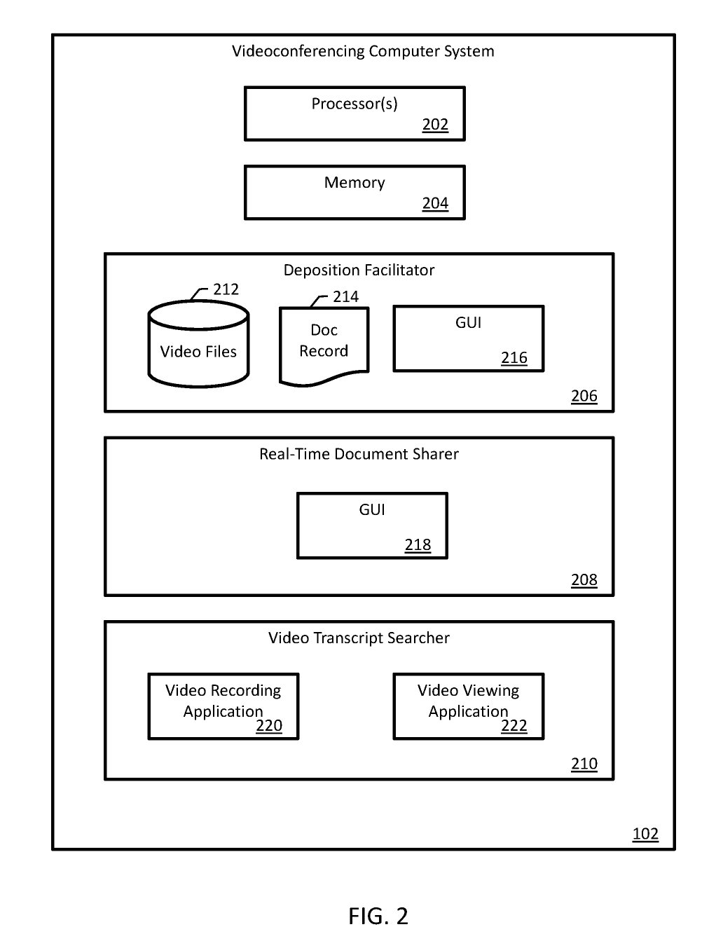

FIG. 2 is a block diagram of the example videoconferencing computer system 102. The videoconferencing computer system 102 includes one or more processors 202 and memory 204 storing one or more computer programs executable by the processors 202. For example, the videoconferencing computer system 102 can be a server implemented on a distributed computing system.

In some examples, the videoconferencing computer system 102 includes a deposition facilitator 206 implemented by the processors 202 and memory 204. The deposition facilitator 206 is configured by appropriate programming for establishing, for a deposition, a videoconferencing session between a plurality of users 104a-c including at least a witness 104b and a deposing attorney 104a by transmitting display information to a respective user computer 106a-c for each user over a data communications network 108; presenting, during the deposition and at each user computer 104a-c, a graphical user interface 216 displaying: a first panel displaying a real-time video of the witness captured from a camera coupled to or integrated with the user computer of the witness; and a second panel displaying a view of a selected document from a plurality of electronic documents uploaded by the deposing attorney so that each user computer displays in real-time the view of the selected document; and storing, after the deposition, a video file of the real-time video of the witness in a repository 212 and a timestamped record 214 of a plurality of displayed documents displayed in the second panel during the deposition.

In some examples, the videoconferencing computer system 102 includes a real-time document sharer 208 implemented by the processors 202 and memory 204. The real-time document sharer 208 is configured by appropriate programming for establishing a videoconferencing session between a plurality of users 104a-c by transmitting display information to a respective user computer 106a-c for each user over a data communications network 108; presenting, at each user computer, a graphical user interface 218 displaying a view of a document so that each user computer displays in real-time the view of the selected document; and in response to a controlling user (for example, a deposing attorney 104a) manipulating the document in the videoconferencing session, updating the view of the document at each other user computer (106b-c) by transmitting document state information to each other user computer over the data communications network.

In some examples, the videoconferencing computer system 102 includes a video transcript searcher 210 implemented by the processors 202 and memory 204. The video transcript searcher 210 is configured by appropriate programming for providing, to a user computer 106a over a data communications network 108, a video viewing application 222; receiving, from the video viewing application executing on the user computer, a search request including one or more search terms to search for in a video having a corresponding audio file (for example, a video recorded by a user computer executing the video recording application 220); and in response to receiving the search request, providing one or more search results to the video viewing application executing on the user computer, each search result indicating a portion of the video where a corresponding portion of the audio file has been transcribed to text matching the one or more search terms.

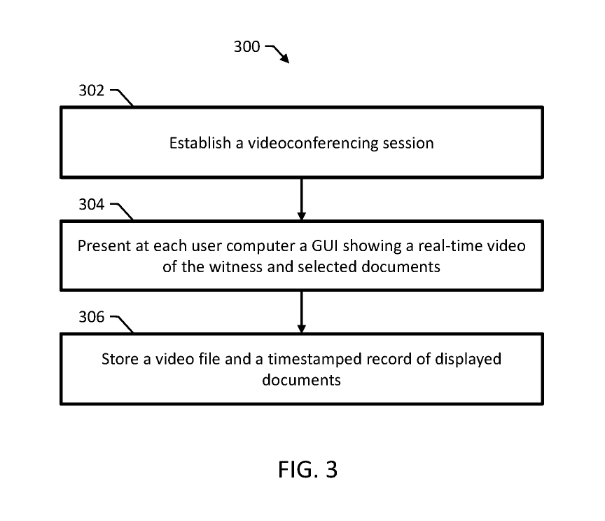

FIG. 3 is a flow diagram of a method 300 performed by the deposition facilitator 206. The method 300 includes performing operations as described above with reference to FIG. 2. The following paragraphs further describe the deposition facilitator 206 and one or more optional features of the deposition facilitator 206.

Purpose of System

The system allows attorneys to conduct legal depositions remotely by using a web application that consists of a video meeting which is recorded and a document sharing mechanism. The video session is recorded and available for replay at a later time providing a better form of evidence than the transcript product of traditional depositions. The entire process can be setup and the deposition started in a matter of minutes.

How the System is an Improvement

The traditional legal deposition process requires attorneys to plan depositions weeks or months in advance due to scheduling and travel conflicts. Additionally it requires the presence of a court reporter in order to generate the transcript. There are existing remote legal deposition products that employ video—however they require the presence of a court reporter. The system proposes to improve on this process by allowing the entire deposition process to be conducted remotely—thus eliminating travel considerations and easing scheduling difficulties. Additionally, the product of the tool is a recorded video which provides a better form of evidence than a transcript in a legal setting.

Problems with Current Techniques

The legal industry conducts depositions in much the same manner as they were conducted prior to the system of the computer. There are several problems with that manner which can be solved through the use of technology:
1. Depositions currently require the presence of a court reporter which is an added cost and can cause scheduling problems.
2. The product of a deposition is a transcript which does not provide details that may be contained in an audio and video recording.

Improvements by the System
1. By conducting the deposition through a remote, recordable, video session the system can alleviate the requirement of having a court reporter present for legal depositions, depending on jurisdictional laws.
2. The web application is always available in unlimited supply alleviating scheduling problems that arise due to the court reporter requirement.
3. The video resulting from the use of the web application is a better form of legal evidence than a textual transcript.

Steps to Build the System
1. Start by creating a simple web and/or mobile application backed by a RDBMS that allows users to sign up and login.
2. Create the ability for a user to create a logical entity from here on referred to as a deposition room. This user will be called the deposing attorney.
3. Give the deposing attorney the opportunity to enter meta data about the deposition room.
4. Give the deposing attorney the ability to invite other users to be associated with the deposition room via email. The other users will be one of three classes: the witness, the opposing counsel, and additional attendees.
5. Give the deposing attorney the ability to upload PDF documents that are associated with the deposition room.
6. Give the deposing attorney the ability to reach a screen that is a visual representation of the deposition room via a link or a button.
7. In the emails inviting the witness, opposing counsel, and attendees to the deposition room include a URL that will take them to the website or mobile app. The user is then allowed to login or signup for an account. After logging in or signing up the user is directed to a screen that is a visual representation of the deposition room.
8. The visual representation of the deposition room will consist of the following:
   a. Video of the witness (and optionally the deposing attorney, opposing counsel, and attendees) captured from the user's device's camera.
   b. If the user is the deposing attorney there is a section consisting of controls consisting minimally of a button to start recording, a button to stop recording, and a button to end the deposition.
   c. A section showing the documents uploaded in 5.
   d. A section that allows the documents from 8.c. to be displayed on the screen
9. The visual representation of the deposition room will function as follows if the user is the deposing attorney:
   a. Start recording button—when clicked this button causes the application to start recording the video from 8.a.
   b. Stop recording button—when click this button causes the application to stop recording the video from 8.a.
   c. List of documents—when a document is clicked the application will display the document to the deposing attorney.
   d. Document introduction button—when clicked, this button causes the application to put a timestamp on the document and display it on the screen of any other user viewing the visual representation of the deposition room
   e. End deposition button—when clicked, this button causes the application to direct all users away from the screen with the visual representation of the deposition room.
10. The visual representation of the deposition room will function as follows if the user is the witness, opposing counsel, or other attendee:
   a. The video section from 8.a. shows live video from the witness and optionally all other users.
   b. The list of documents will only show documents that have been introduced by the deposing attorney via 9.d.
   c. There is a section of the screen where documents will be displayed when they are introduced by the deposing attorney via 9.d.
11. When the deposition is ended by the deposing attorney via 9.d. all users are sent to another screen and the deposition is deemed to have ended. The deposing attorney, and optionally other users, will have a link on this screen to enter a review screen.
12. The review screen allows the user the following:
   a. To see the list of users who were associated with the deposition room
   b. To see and download the documents associated with the deposition room
   c. To download the archived videos created during the deposition

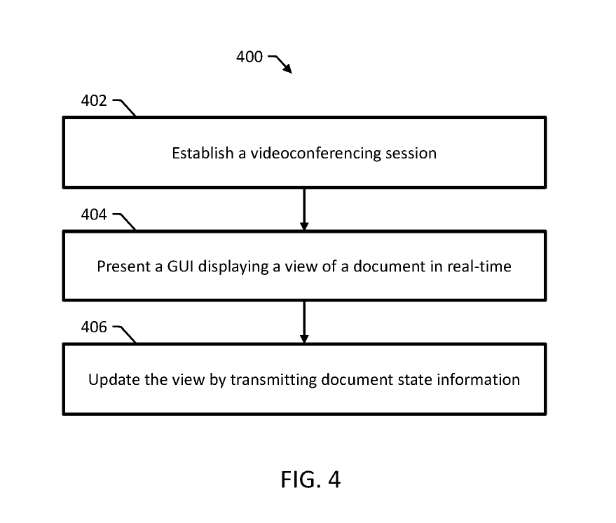

FIG. 4 is a flow diagram of a method 400 performed by the real-time document sharer 208. The method 400 includes performing operations as described above with reference to FIG. 2. The following paragraphs further describe the real-time document sharer 208 and one or more optional features of the real-time document sharer 208.

Purpose of System

The system allows all users of a web application to have the same view of a PDF document at the same time with little network overhead compared to current approaches to document sharing in real time applications.

How the System is an Improvement

Currently, in order for users of an application to have the same view of a PDF document one would need to use screen sharing software that may or may not require a program to be installed on their device and consumes a large amount of bandwidth as the user's screen is streamed. The system described in this document does not require any software to be installed (apart from the web browser already being used to interact with the application) and uses significantly less bandwidth than a screen sharing tool by sending messages about the state of the document over HTTP or web sockets.

Problems with Current Techniques

Currently, using screen sharing technology is how to achieve the effect of the proposed system. The problems with screen sharing technology are that it may require additional software installation or special permissions on the user's device and that it consumes a relatively large amount of bandwidth compared to the system.

Improvements by the System

The system improves on current techniques by using Javascript to display the document in the web application which means that additional software does not need to be installed on the user's device. Additionally, it communicates with the other users' devices by sending and receiving messages to a server using HTTP or web sockets which results in significantly less bandwidth consumption.

Steps to Build the System
1. Use Javascript to display the PDF document in the web application. This can be accomplished using a custom solution or an open source library such as PDF.js.
2. For the user controlling the view of the document, build a system in Javascript that monitors the state of the document.
3. When the system described in #2 detects a change in the state of the document, send a message to the server brokering the web application using AJAX (if HTTP) or web sockets.
4. On the server use one of the following techniques to communicate the new view of the document to the other users depending on the approach chosen:
   a. If using HTTP, store the message in a database and wait for the other users to request information regarding the change in the state of the document
   b. If using web sockets, send the message to the other users
5. For the users viewing the document use one of the following techniques to receive messages about changes in the state of the document:
   a. If using HTTP, periodically poll the server using AJAX and ask for changes in the state of the document
   b. If using web sockets, build a javascript function that will be invoked by the server when a new message has been received.
6. When a new message about the state of the document is received, use the component described in #1 to update the view of the document.

How the System Works

When the system is built as described above, the user with control of the document can scroll through the document or highlight text in the document. When that happens the other users' view of the document will change to reflect the scrolling or text highlighting.

Additional Considerations

There are two additional considerations that can expand on the system:
1. The system can be adapted to allow the web application to change control of the document to a different user. For example, User A is in control of the document and all other users see the document as he changes the view of it. He could then pass control of the document to User B via the web application so that all other users (including User A) would then see the document as User B changes the view of it.
2. The system can be expanded to include other types of documents such as word processor document, spreadsheets, or images.

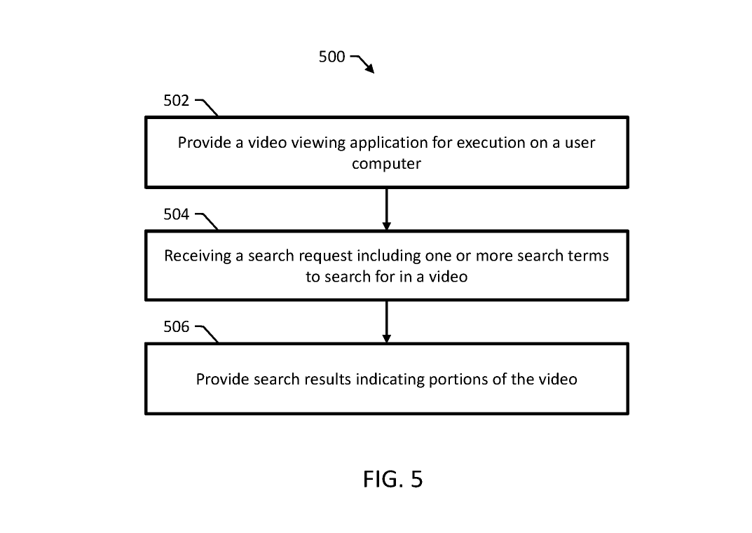

FIG. 5 is a flow diagram of a method 500 performed by the video transcript searcher 210. The method 500 includes performing operations as described above with reference to FIG. 2. The following paragraphs further describe the video transcript searcher 210 and one or more optional features of the video transcript searcher 210.

Purpose of System

The system will allow users to navigate to a certain point in a recorded video by searching for a specific word spoken in the video.

How the System is an Improvement

Currently, if a user wants to find a portion of a recorded video that discusses a certain topic they would have to either 1) watch the video in its entirety until it reaches the desired point or 2) arbitrarily jump to different points in the video until the desired portion is found. When searching the Internet for searchable or indexable video, you find many articles about how to increase SEO rankings of websites with video, but not any products solving the problems addressed by the system.

Improvements by the System

The system improves the state of the art by making it much easier to jump to a specific point in a video. As video continues to become a more dominant form of media it will be used in manners it hasn't before. Take the legal industry for example, as video becomes more dominant and universally accepted it is likely it will start to replace transcription. In a transcript of a legal proceeding there is typically an index that will tell you on which pages of the transcript a certain word appears. The system is applying the same concept to video.

Steps to Build the System

Part 1—Transcription and Timestamping
1. In a video recording based web or mobile application modify the portion of the application that interacts with the devices video and audio hardware so it will capture the audio stream and deliver it in chunks while recording is occurring.
2. When a chunk of audio is captured, note the length of the video and use it to calculate the point in the recording that the chunk started. Send that timestamp, the audio chunk, and any other application specific data (e.g. unique identifier for the recording) to a server side application via a standard protocol (likely HTTP(S) or WS(S)).
3. When that data is received by the server side application, make an entry in a relational database table that will serve store the information necessary to perform the indexing. At this time the timestamp and application specific data from step 2 should be stored in this table and the server side application should retrieve a unique identifier for that record.
4. Next the server side application uses a cloud based speech to text service (e.g. Google Cloud Speech API) and sends the audio chunk receive in step 2 to the speech to text service. When the speech to text service returns the transcribed text from the audio chunk, the server side application uses the unique identifier from the database record from step 3 to update that record with the transcribed text.
5. Repeat steps 2-4 for each audio chunk until the recording is completed.

Part 2—Indexable Video Viewer Application
6. For the video recording from Part 1 an index enable video viewing application must be built. This page (“Client”) should minimally include 1) a mechanism for viewing the video that can be programmatically interfaced with (e.g. HTML5 video element) and 2) an AJAX or WebSocket enabled form and list that allows a user to search for a term and display the results of the search.
7. Build the form such that when a user enters a term the application will send a request to a server side application with that search term and any required application specific data (e.g. unique identifier for the recording). The server side application will search the transcribed text for this recording in the database table from steps 3 and 4 for the search term. It will then send the results back to the Client along with any relevant data from the results (e.g. timestamps).
8. When the Client receives the results from the server side application it will display the data to the user in a manner such that they can select which of the results they want to jump to in the video viewer.
9. When the user clicks on one of the results, the Client's code (likely Javascript) grabs the timestamp for that results and moves the video viewer that point in the recording and starts playing back the recording from that point.

How the System Works

The net effect of Part 1 from above should not result in a change to the user experience of recording a video in a web or mobile app. However, the changes in Part 1 make it possible to build a new experience in Part 2 that is not currently available. Users will now be able to take recordings and go the viewer described in Part 2 and search for a word spoken in the recording and jump directly to that point in the video.

Additional Considerations

You can add on to this system by modifying the video recording application that was modified in Part 1 above such that the server sends the transcribed text to the Client(s) to provide a real-time transcription experience.

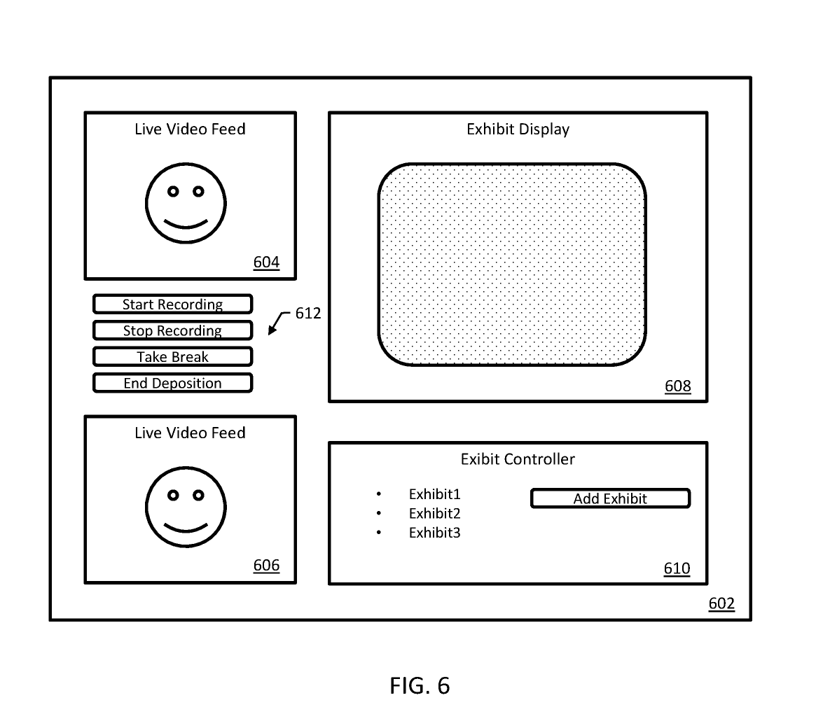

FIG. 6 shows a screen shot of an example video conferencing GUI 602. The GUI 602 is an example implementation of the GUI 216 of FIG. 2. The GUI 602 can be displayed on each user device of the participating users.

The GUI 602 includes multiple live video feeds 604 and 606 to display users participating in a deposition videoconference. The GUI 602 includes an exhibit display 608 and an exhibit controller 610. A controlling user can use the controls displayed in the exhibit controller 610 to select exhibits (e.g., by navigating to files stored on a local or remote computer) to add to a list of available exhibits. The controlling user can then select an exhibit from the list for display in the exhibit display 608. The GUI 602 can include controls 612 for starting and stopping recording, for taking a break, and for ending the deposition.

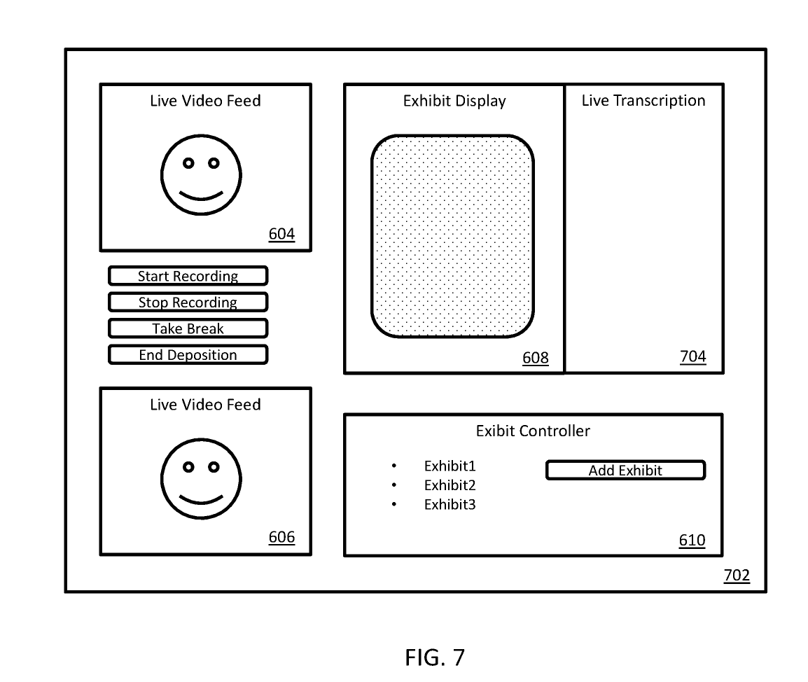

FIG. 7 shows a screen shot of an example video conferencing GUI 702 including a live transcription window 704. In operation, the live transcription window 704 shows a live transcription of the deposition. For example, the computer server hosting the deposition videoconference can repeatedly perform machine transcription of the recorded deposition audio and transmit the resulting text output to the user devices for display in the live transcription window 704. In some examples, the computer server performs machine transcription at periodic time intervals; in some other examples, the computer server performs machine transcription in response to a signal such as a break in the audio file or a change in the view of a document displayed in the exhibit display 608.

The live transcription window 704 can be placed next to the exhibit display 608 or overlaid over a portion of the exhibit display or otherwise displayed in an appropriate area of the GUI 702. In some examples, the live transcription window 704 is activated by a tab as a fly-out over the exhibit display 608.

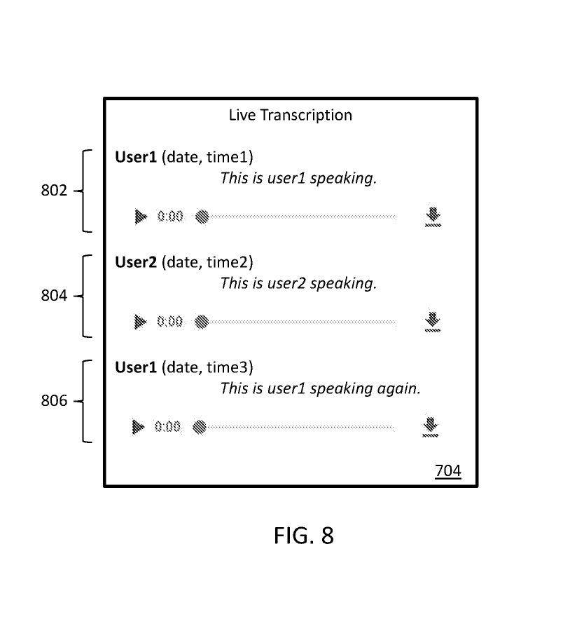

FIG. 8 shows a detailed view of an example of the live transcription window 704. The live transcription window 704 displays rows 802, 804, and 806 of transcribed text. Each row displays a block of text spoken by a user. The live transcription window 704 creates a new row when a different user begins speaking. In some examples, each row 802, 804, and 806 displays a user identifier (e.g., the user's name) and a timestamp. In some examples, each row 802, 804, and 806 includes a set of controls to replay and/or download the portion of the deposition audio file corresponding to the transcribed text displayed in the row.

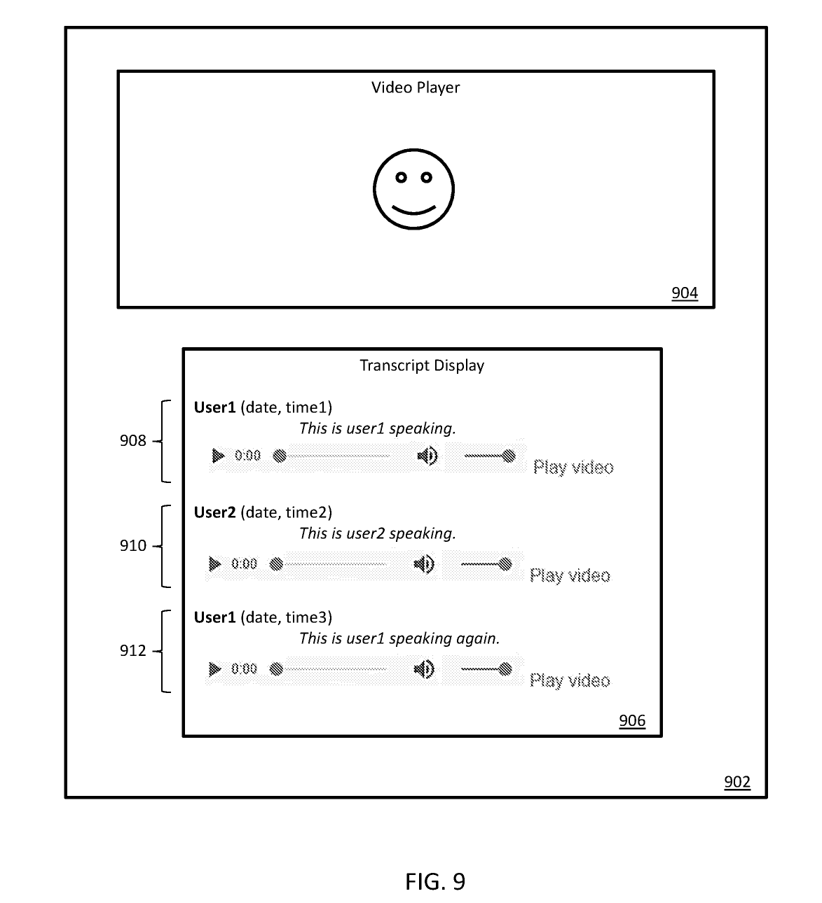

FIG. 9 shows a screen shot of an example video conferencing GUI 902 for analyzing a deposition videoconference, e.g., after the videoconference has ended. The GUI 902 includes a video player 904 and a transcript display window 906. The transcript display window 906 includes controls for displaying portions of the recorded deposition video file in the video player 904.

The transcript display window 906 displays rows 908, 910, and 912 of transcribed text. Each row displays a block of text spoken by a user. The transcript display window 906 creates a new row when a different user begins speaking. In some examples, each row 908, 910, and 912 displays a user identifier (e.g., the user's name) and a timestamp. In some examples, each row 802, 804, and 806 includes a set of controls to replay the portion of the deposition video file corresponding to the transcribed text displayed in the row.

Although specific examples and features have been described above, these examples and features are not intended to limit the scope of the present disclosure, even where only a single example is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed in this specification (either explicitly or implicitly), or any generalization of features disclosed, whether or not such features or generalizations mitigate any or all of the problems described in this specification. Accordingly, new claims may be formulated during prosecution of this application (or an application claiming priority to this application) to any such combination of features. In particular, with reference to the appended claims, features from dependent claims may be combined with those of the independent claims and features from respective independent claims may be combined in any appropriate manner and not merely in the specific combinations enumerated in the appended claims.

### Definitions

The terminology used herein is for the purpose of describing particular embodiments only and is not intended to be limiting of the presently disclosed subject matter.

While the following terms are believed to be well understood by one of ordinary skill in the art, the following definitions are set forth to facilitate explanation of the presently disclosed subject matter.

All technical and scientific terms used herein, unless otherwise defined below, are intended to have the same meaning as commonly understood by one of ordinary skill in the art. References to techniques employed herein are intended to refer to the techniques as commonly understood in the art, including variations on those techniques or substitutions of equivalent techniques that would be apparent to one skilled in the art. While the following terms are believed to be well understood by one of ordinary skill in the art, the following definitions are set forth to facilitate explanation of the presently disclosed subject matter.

In describing the presently disclosed subject matter, it will be understood that a number of techniques and steps are disclosed. Each of these has individual benefit and each can also be used in conjunction with one or more, or in some cases all, of the other disclosed techniques.

Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Following long-standing patent law convention, the terms “a”, “an”, and “the” refer to “one or more” when used in this application, including the claims. Thus, for example, reference to “a unit cell” includes a plurality of such unit cells, and so forth.

Unless otherwise indicated, all numbers expressing quantities of ingredients, reaction conditions, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about,” when referring to a value or to an amount of a composition, mass, weight, temperature, time, volume, concentration, percentage, etc., is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

The term “comprising”, which is synonymous with “including” “containing” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter. With respect to the terms “comprising”, “consisting of”, and “consisting essentially of”, where one of these three terms is used herein, the presently disclosed and claimed subject matter can include the use of either of the other two terms.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

1. A computer system comprising one or more processors and memory, wherein the computer system is programmed to perform operations comprising:
establishing, for a deposition, a videoconferencing session between a plurality of users including at least a witness and a deposing attorney by transmitting display information to a respective user computer for each user over a data communications network;
presenting, during the deposition and at each user computer, a graphical user interface displaying:
a first panel displaying a real-time video of the witness captured from a camera coupled to or integrated with the user computer of the witness; and
a second panel displaying a view of a selected document from a plurality of electronic documents uploaded by the deposing attorney so that each user computer displays in real-time the view of the selected document; and
storing, after the deposition, a video file of the real-time video of the witness and a timestamped record of a plurality of displayed documents displayed in the second panel during the deposition.

2. The computer system of claim 1, wherein establishing the videoconferencing session comprises: executing a web server to host a user account creation web page and a user login web page; creating user accounts in a database for the users using the user account creation web page; and receiving logon credentials from the users using the user login web page.

3. The computer system of claim 1, wherein establishing the videoconference session comprises: receiving a list of invitees from the user computer of the deposing attorney; and inviting, by transmitting one or more messages over the data communications network, the invitees on the list of invitees to the deposition.

4. The computer system of claim 1, wherein the operations comprise presenting, at the graphical user interface displayed on the user computer of the deposing attorney, a control panel comprising: a first user interface element to start recording the video file, a second user interface element to stop recording the video file, and a panel to display a list of the plurality of electronic documents uploaded by the deposing attorney.

5. The computer system of claim 1, wherein the operations comprise presenting, at the graphical user interface displayed on the user computer of the deposing attorney, a document introduction user interface element for selecting the selected document to be displayed in the second panel at each user computer and adding the selected document to the timestamped record and timestamping the selected document in the timestamped record.

6. The computer system of claim 1, wherein the operations comprise presenting, at the graphical user interface displayed on the user computer of the deposing attorney and after the deposition has ended, a review panel displaying a list of the users, the timestamped record of the plurality of displayed documents, and the video file.

7. The computer system of claim 1, wherein the operations comprise presenting, during the deposition and at each user computer, a third panel of the graphical user interface displaying a real-time transcription of the deposition.

8. (canceled)

9. (canceled)

10. (canceled)

11. (canceled)

12. (canceled)

13. (canceled)

14. (canceled)

15. (canceled)

16. A computer system comprising one or more processors and memory, wherein the computer system is programmed to perform operations comprising:
establishing a videoconferencing session between a plurality of users by transmitting display information to a respective user computer for each user over a data communications network;
presenting, at each user computer, a graphical user interface displaying a view of a document so that each user computer displays in real-time the view of the document; and
in response to a controlling user manipulating the document in the videoconferencing session, updating the view of the document at each other user computer by transmitting document state information to each other user computer over the data communications network.

17. The computer system of claim 16, wherein transmitting document state information comprises transmitting the document state information over HTTP or web sockets.

18. The computer system of claim 16, wherein updating the view of the document at each user computer comprises:
storing one or more document state messages from the user computer of the controlling user and waiting for the other user computers to request information regarding a change in the document state information; or
transmitting the document state information in response to receiving the one or more document state messages from the user computer of the controlling user.

19. The computer system of claim 16, wherein presenting the graphical user interface at the user computer for the controlling user comprises causing the user computer for the controlling user to execute a display script to display the document in a web application executing on the user computer for the controlling user.

20. The computer system of claim 19, wherein executing the display script comprises monitoring a display state of the document and transmitting one or more document state messages to the computer system.

21. The computer system of claim 16, wherein presenting the graphical user interface at each user computer comprises causing each user computer to execute a display script to:
periodically poll the computer system to request information regarding a change in the document state information; or
provide a function to be invoked by the computer system in response to the computer system receiving one or more document state messages from the user computer for the controlling user.

22. (canceled)

23. (canceled)

24. (canceled)

25. (canceled)

26. (canceled)

27. (canceled)

28. (canceled)

29. A computer system comprising one or more processors and memory, wherein the computer system is programmed to perform operations comprising:
providing, to a user computer over a data communications network, a video viewing application;
receiving, from the video viewing application executing on the user computer, a search request including one or more search terms to search for in a video having a corresponding audio file; and
in response to receiving the search request, providing one or more search results to the video viewing application executing on the user computer, each search result indicating a portion of the video where a corresponding portion of the audio file has been transcribed to text matching the one or more search terms.

30. The computer system of claim 29, wherein the operations comprise indexing the video during or after recording the video by:
receiving, from a video recording application executing on a recording user computer, an audio chunk and data specifying a corresponding portion of the video;
creating an entry in a database with the data specifying the corresponding portion of the video; and
receiving transcribed text for the audio chunk and adding the transcribed text to the entry in the database.

31. The computer system of claim 30, the operations comprising repeatedly receiving additional audio chunks and creating entries in the database until the video is completely transcribed.

32. The computer system of claim 30, the operations comprising sending, in response to receiving the transcribed text, the transcribed text to the video recording application to display a real-time transcription of the video while the video recording application is recording the video.

33. The computer system of claim 29, wherein providing the video viewing application comprises providing an HTML video element and an AJAX or WebSocket enabled form and list configured for a user to enter search terms and display search results.

34. The computer system of claim 29, wherein providing the video viewing application comprises configuring the video viewing application to jump to a selected portion of the video corresponding to a selected search result.

35. (canceled)

36. (canceled)

37. (canceled)

38. (canceled)

39. (canceled)

40. (canceled)

41. (canceled)
